(19) United States
(12) Patent Application Publication
(10) Pub. No.: US 2005/0051108 A1
(43) Pub. Date: Mar. 10, 2005

(54) PET PLAYHOUSE

(75) Inventors: George S. Syrigos, Meta, MO (US); Christopher S. Syrigos, Perrysburg, OH (US); Emmanuel S. Syrigos, St. Peters, MO (US)

Correspondence Address: BLACKWELL SANDERS PEPER MARTIN LLP, 720 OLIVE STREET, SUITE 2400, ST. LOUIS, MO, 63101, US

(73) Assignee: KITTY KINGDOM, INC., Perrysburg, OH (US)

(21) Appl. No.: 10/605,113

(22) Filed: Sep. 9, 2003

(51) Int. Cl. A01K 1/00

(52) U.S. Cl. 119/416

(57) ABSTRACT

A pet playhouse is provided. The playhouse includes the plurality of enclosures each having at least two rooms therein. The enclosures are comprised of an upstanding sidewall and a plurality of floors each connected to a respective sidewall with the floors and the sidewall defining the interior rooms. A plurality of passages are provided to provide ingress into and out of the playhouse and between the enclosures.

### BACKGROUND OF INVENTION

The present invention relates to a playhouse for use by pets such as cats and ferrets. Animal playhouses are known in the art, see for example U.S. Pat. No. 5,050,536. The '536 patent discloses a playhouse that has multiple floors with holes to provide access between the floors. The playhouse is designed to be collapsible to form a square or rectangular cross section for storage or shipping. The floors are supported by underlying beams, a portion of which extends through holes in the sidewall of the playhouse. U.S. Pat. No. 5,320,065 shows an animal playhouse that utilizes offset openings having ramps 81 to provide movement between the floors. U.S. Design Pat. No. 469,584 shows a pet house. U.S. Pat. No. 6,209,490 discloses an animal container for use in commercial settings to confine animals, for example, at a store. It is disclosed that individual units are designed to be stacked vertically or positioned side by side.

While animal playhouses are known, they tend to be of complicated structure, do not provide serpentine paths for traversing by the pet, can be unstable if made tall because of the small “footprint” provided at the base of the playhouse and can be assembled in only one form.

The present invention provides an improved playhouse for animals that overcome deficiencies of the prior art playhouses.

### BRIEF DESCRIPTION OF DRAWINGS

FIG. 1 is a perspective view of the playhouse of the present invention.

FIG. 2 is an exploded perspective view of the playhouse of FIG. 1.

FIG. 3 is an exploded perspective view of the central tower.

FIG. 4 is a top plan view of the playhouse of FIG. 1.

FIG. 5 is a front elevation view of the playhouse of FIG. 1.

FIG. 6a is an enlarged fragmentary perspective view of the playhouse showing the connection of the floors to the sidewalls.

FIG. 6b is an enlarged fragmentary perspective view showing the securement devices for securing each of the towers in their final shape and the towers together.

FIG. 7 is a series of schematic plan views showing various shapes and positions of assembled enclosures.

FIG. 8 is a perspective view of the central enclosure with exterior portions shown in phantom to view the enclosure interior.

Like numbers throughout the various figures designate like or similar parts.

### DETAILED DESCRIPTION

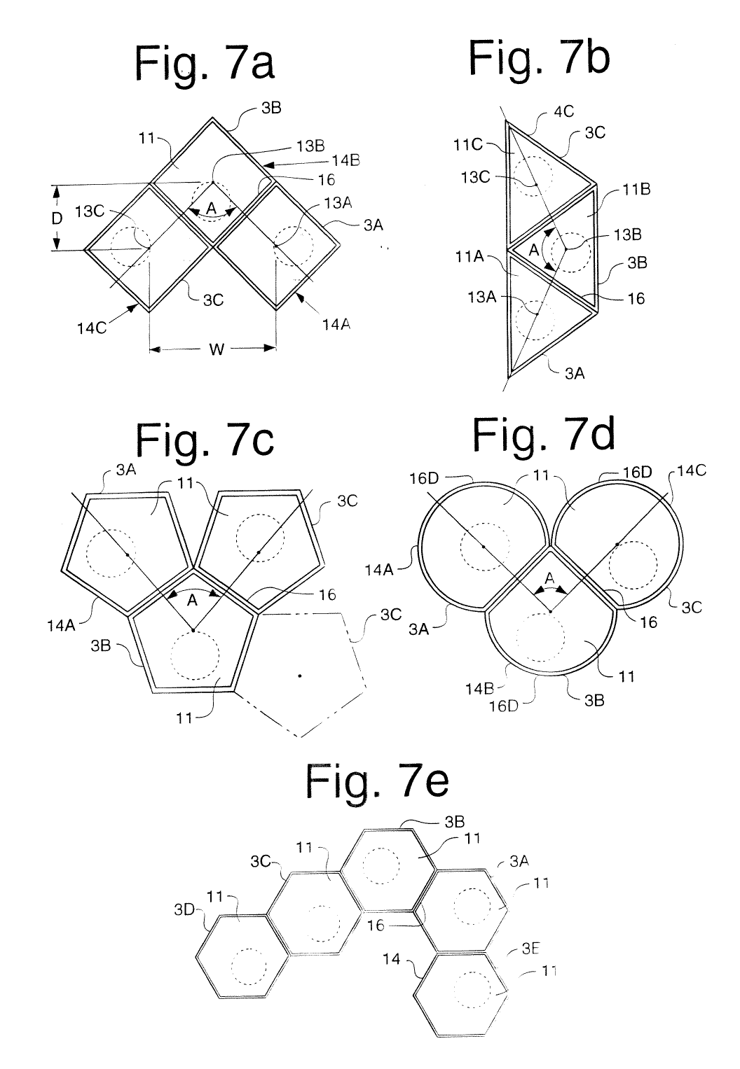

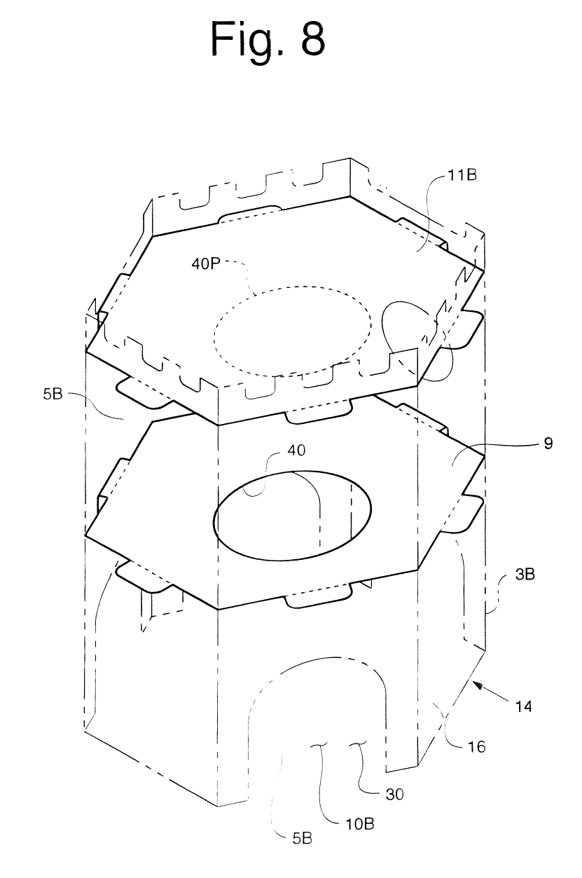

The reference numeral 1 designates generally a playhouse structure comprising a plurality of enclosures 3 shown as being interconnected towers. The enclosures 3 will be hereinafter referred to as towers, and are denoted as 3A, B, C for distinction. The towers 3 which are connected together to form a unitary playhouse 1. The playhouse 1 is provided with one or more entries 7 preferably at ground level and at least one floor 9 in each tower 3 dividing the interior 10 (denoted 10A, B, C in the towers 3A, B, C respectively) into a plurality of rooms 5 (also denoted 5A, B, C for distinction). The rooms 5 in a tower 3 are in stacked relation and are side by side-by-side in adjacent tower. Each tower 3 may be provided with either a roof 11 or floor 9 adjacent to the top thereof with a roof 11 being shown on all towers. The suffixes A, B, C will be used to differentiate the parts on the towers 3 A, B, C respectively when needed for distinction. Each of the towers 3 has a sidewall 14 with a plurality of panels 16, as hereinafter described, at least one of which is generally planar. The generally planar panel 16 of one tower 3 is adjacent to and abuts a generally planar panel 16 of an adjoining tower when the towers are secured together. The sidewalls 14 are designated 14A, B, C for the towers 3A, B, C respectively. The towers 3 are preferably positioned relative to one another to provide a stable structure preferably with a multi-axis arrangement of longitudinal axes 13A, B, C, (Figs. of the towers 3. In the preferred embodiment and as best in FIG. 7, the longitudinal axes 13 A, B, C are arranged in a generally V shaped configuration and provide both a depth D and width W to the footprint (see for example, FIG. 7a), as defined by the positions of the longitudinal axes of the playhouse 1 for stability and compactness.

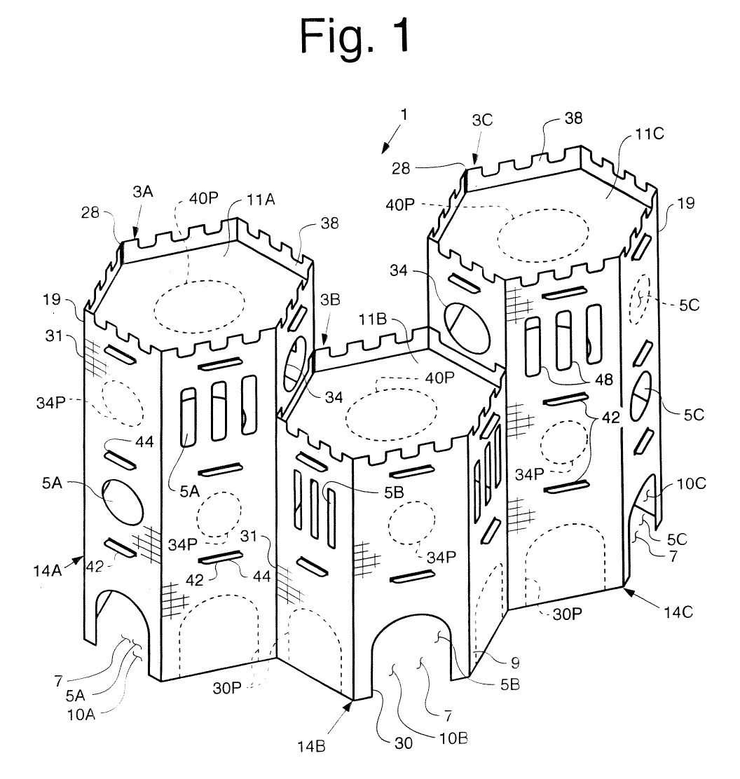

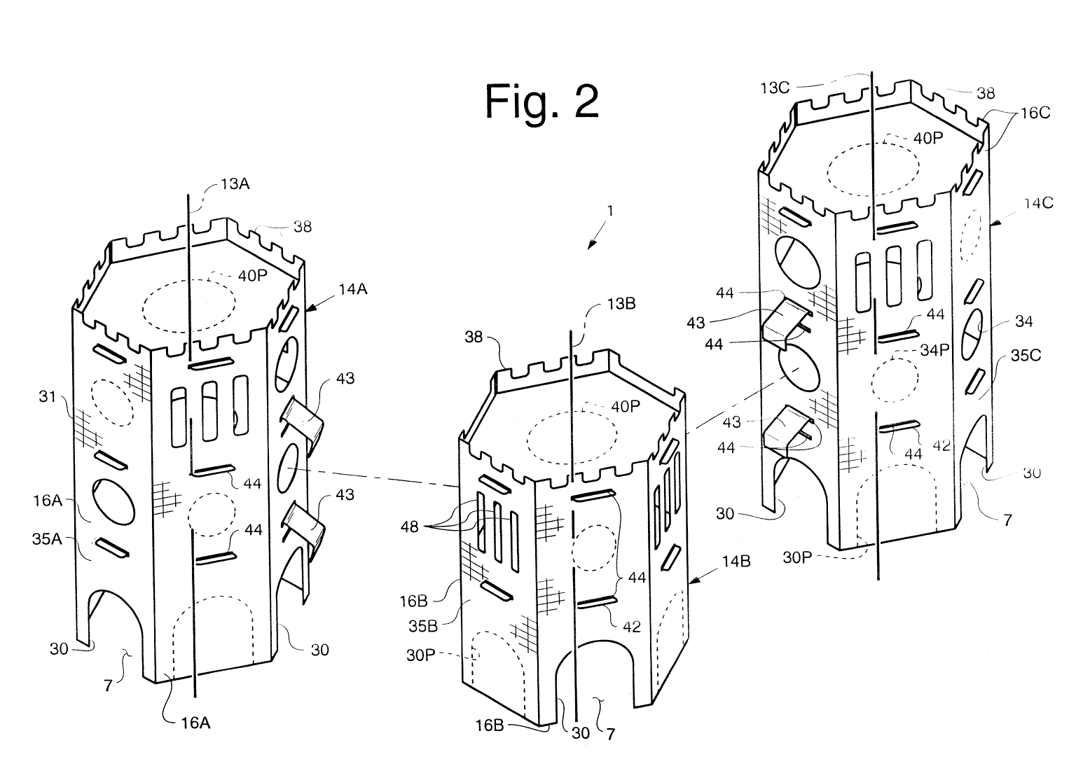

The towers 3 may have similar structures. In the illustrated structure of FIGS. 1, 2, the towers 3 have substantially identical structures. FIG. 7d illustrates tower configurations which are similar, e.g., the use of non-planar panels 16D in combination with one or two planar panels. The tower 3B has a structure similar to towers 3A; C but is shorter in height which provides a roof 11 accessible from the towers 3A, C. For simplicity, the towers 3 in the description below will be described as identical even though they may vary slightly in construction. The towers 3 each have a sidewall 14. As shown, each sidewall 14 has a plurality of interconnected panels 16 respectively at least one of which is generally planar. The panels 16 of each tower 3 are connected together. In use, the sidewalls 14 are upstanding and preferably generally vertical. The panels 16 in each tower 3 may be generally uniform in shape and size, are preferably rectangular and are connected together at fold lines or corners 19 with the fold lines 19 also extending generally vertically. Each tower 3 includes one or more floors 9 with the towers 3A, C including a plurality of floors 9 which also function as ceilings for a below located room 5. The tower 3B includes one floor 9 and one roof 11. The floors 9 in the illustrated structure of FIG. 1 and FIGS. 7a-c are substantially identical. In the illustrated structure, the difference between a floor 9 and roof 11 is their location with the roof being located adjacent the top of a respective tower 3. Each floor 9 has a plurality of side edges 23 corresponding to the number of panels 16 of the respective tower 3 and are sized to provide a close fit between the edges 23 and the inside surface of the respective tower. The floors 9 and roofs 11 each have a perimeter sized and shaped generally corresponding to the interior size and shape or the transverse cross section of the tower 3. Preferably the towers 3 have substantially similar transverse cross sectional sizes and shapes so the floors 9 and roofs 11 are interchangeable between towers 3. However, as seen in Fig. all the towers 3 need not be of similar transverse cross sectional sizes and shapes.

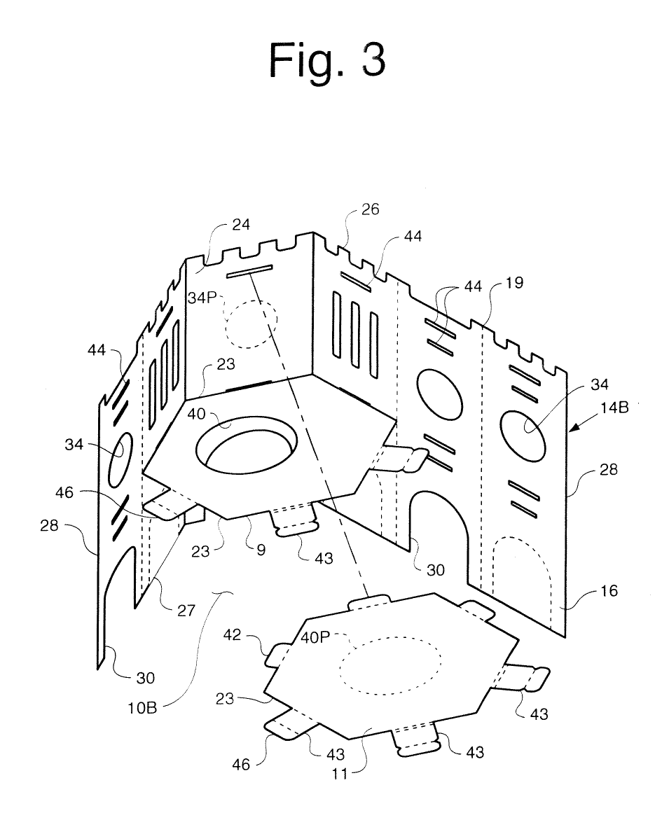

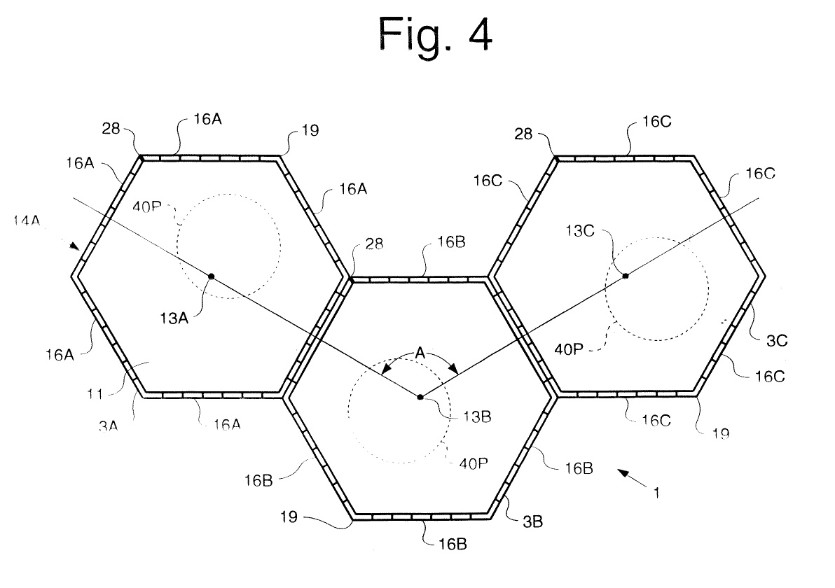

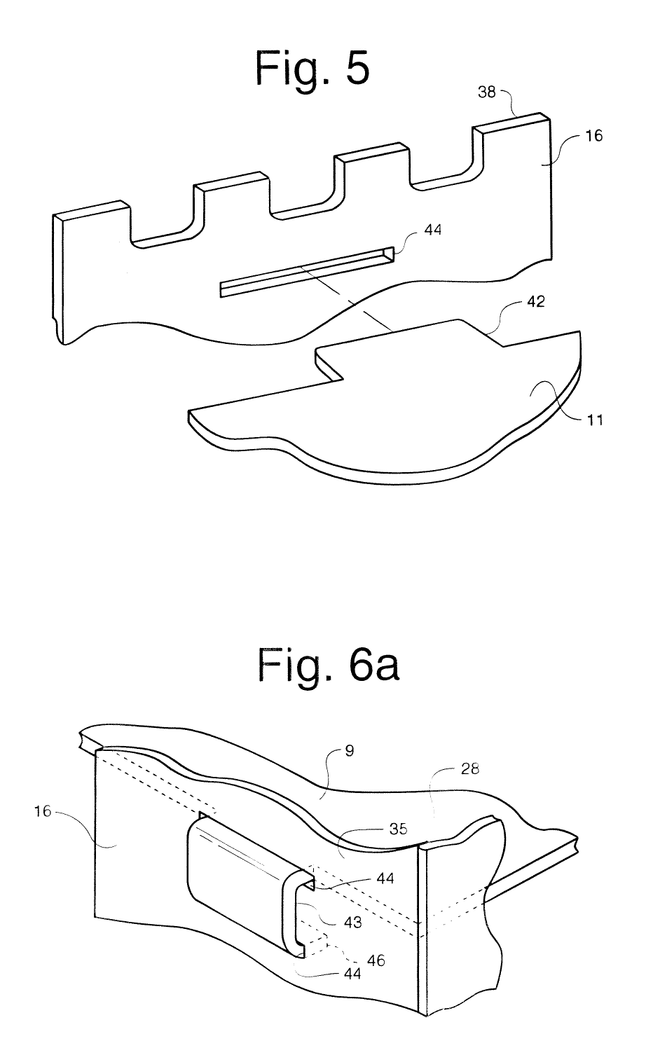

The sidewalls 14 can be formed from a blank of material such as corrugated paperboard or other materials depending upon the strength and durability needed or desired. The floors 9 and roofs 11 may also be formed of suitable material such as corrugated paperboard. As seen, the sidewalls 14 can be made from a generally rectangular blank having top, bottom and side edges 26, 27 and 28 respectively (FIG. 3). The blank can be formed from any suitable material and may be cut or otherwise formed, as for example, by die cutting or the like. Openings 30 may be provided in one or more of the panels 16 to provide a means for ingress into and egress from the ground level rooms 5A, B, C in the interiors 10 A, B, C of the towers 3A, B, C, respectively. The openings 30 can be used as the entry 7 or as a passage at the ground level between the various towers 3 by having selected openings 30 aligned. Ports 34 may also be provided in selected panels 16. When the towers are connected together and the ports 34 are aligned, passages are formed providing for travel between the rooms 5 and the various towers 3. The ports 34 may be provided at each floor level in each tower 3 if desired. The exterior surfaces 35 A, B, C of the sidewalls 14 may be provided with decoration 31 such as for example, simulated rock or other building material. The portions of the sidewalls 14 adjacent the top edges 26 may be in the form of parapets 38 to simulate a castle.

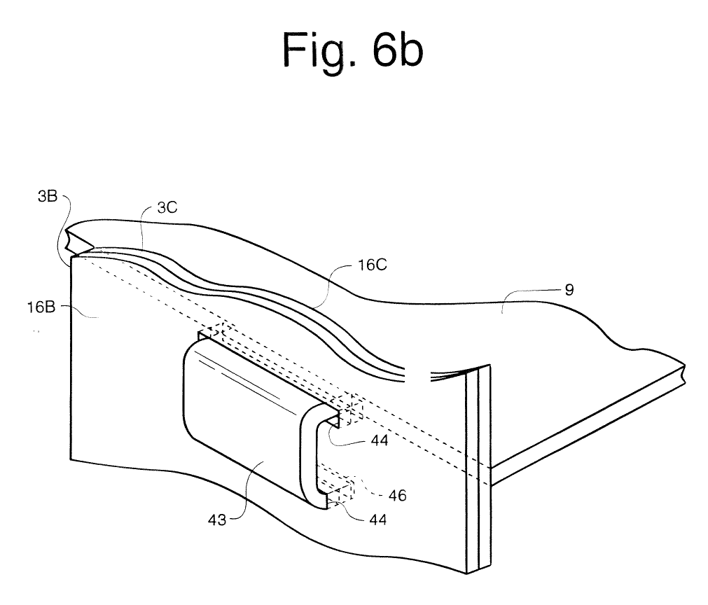

The floors 9 and roofs 11 in a tower 3 have generally similar shapes and constructions. The principal structural difference between the illustrated roofs 11 and floors 9 for a tower 3 is the provision of a portal 40, FIG. 3, through the floors 9 to provide a means of travel through the floors. In the illustrated structure, the roofs 11 are shown as continuous, i.e., without a portal 40. However, if it is desired, a portal 40 could be provided in a roof 11. The use of a roof 11 with a portal 40 may be desirable for one type of pet but not for another. The floors 9 and roofs 11 have the peripheral edge portions 23 preferably in the same number as the panels 16 of a sidewall 14. Preferably, each of the edges 23 includes an ear 42 or 43 projecting therefrom for receipt through a respective slot 44 through a respective panel 16. The ears 42, 43 will support a floor 9 or roof 11 on its respective sidewall 14. Means are provided to retain each of the towers 3 in its multi-sided configuration with the side edges 28 of the sidewall 14 being retained adjacent to one another (See FIG. 1, 6a). To prevent the tower 3 from separating at the side edges 28 the ears 43, which are preferably longer than the ears 42, can be bent downwardly after passing through a respective slot 44 to overlie an exterior surface 35 of the respective panel 16 and then have a free end portion 46 pass through a second slot 44 thereby locking the sidewall 14 to the respective floor 9 or roof 11 preventing withdrawal of the ear 43 from a slot 44 and separation of the seam at the abutting side edges 28, FIG. 6a.

The towers 3 can have any suitable multi-sided configuration so long as there is at least one generally planar or flat side to correspond to a corresponding generally planar or flat side of an adjacent and attached tower. For example, the towers 3 may have 3-6 sides. A larger number of sides can be utilized if desired. The towers 3 can also have one generally planar panel 16 in combination with a curved panel 16D, (FIG. 7d). The perimeter shape of the respective floor 9, roof 11 corresponds to the transverse cross sectional shape of the respective tower 3 at the interior surface thereof. It is preferred that the towers 3A, C have at least one generally planar panel 16 which face is at the location where the towers 3A, C abut and are attached to the tower 3B with the tower 3B preferably having at least two generally planar panels 16. The towers 3 are suitably joined together. As shown in FIG. 6b, an elongate ear 43 passes through a pair of corresponding and aligned slots 44 through abutting panels 16. The free end 46 of the ear 43 passes through both sets of aligned slots 44 with a portion of the ear 43 overlying an interior surface of the adjoining tower 3. The orientation of the panels 16 on the towers 3 is such as to provide the desired footprint or footprints. For example, the panels 16 may be orientated at an angle A of 60°, 120° or 180° for a six-sided configuration of towers 3 and 72° or 144° for a 5-sided tower. FIG. 7 shows in schematic form, several tower arrangements using various numbers of panels on a tower. Fig. shows a first configuration of towers 3 and an alternative configuration in phantom. A preferred embodiment uses a six-sided configuration for each of the towers 3. This provides not only a desired footprint having width W and depth D but can also provide clearance between the two side towers 3 A, C. The use of a six-sided tower provides for closely spaced ears 43, 44 and thus a short unsupported span of floor 9 or roof 11 between the ears for resistance to bending under load.

The sidewalls 14 may be provided with a plurality of partially formed ports 34 and openings 30 (denoted 34P, 30P in the drawing) which may be formed by perforating the sidewall 14 but not removing the material inside the perforations. This would allow the consumer to customize the playhouse 1 and to add additional towers 3 to the playhouse 1 as desired. The provision of precursor openings 30P and ports 34P provides versatility in assembly while not providing a means of egress from or ingress into the playhouse 1 except at the desired locations.

The sidewalls 14 may also be provided with a plurality of openings 48 to form windows which can be shaped, sized and positioned for functions such as viewing into or out of the playhouse 1 while preventing ingress or egress. They may also be used as decoration or simulation, for example to simulate a barred window.

As best seen in FIG. 1, a port 34 can be provided in a panel 16 in the towers 3A, C to provide a passage from the tower 3A and/or 3C on to the roof 11B of the tower 3B. The roofs 11 may also be provided with a portal 40, if desired, to allow an animal access from below to the roof 11 of the tower 3, 5. The roofs may be provided with partially formed or precursor ports 40 (denoted 40P in the drawings) which may be formed by perforating the roof but not removing the material inside the line of perforations.

While any number of towers 3 may be joined together in various configurations using the present invention, a suitable playhouse 1 utilizes three towers.

It will be appreciated that the above description relates to the preferred embodiments by way of example only. Many variations on the apparatus for delivering the invention will be obvious to those knowledgeable in the field, and such obvious variations are within the scope of the invention as described and claimed, whether or not expressly described.

1. A pet playhouse comprising:
a plurality of separate enclosures including a first enclosure with a first interior divided into at least two first rooms and at least one first floor and at least one first portal through a first floor to provide for travel through the first floor; and a second enclosure with a second interior divided into at least two second rooms and at least one second floor with at least one second portal to provide for travel through the second floor, said second enclosure being attached to the first enclosure in side-by-side relation;
an entry associated with at least one of the first and second enclosures providing for ingress into and egress from the respective interior; and
a port associated with the first and second enclosures to provide for pet movement between the first and second enclosures;
wherein each enclosure is formed from a generally flat blank folded at a plurality of fold lines to define a plurality of generally flat vertical walls.

2. The pet playhouse of claim 1 including a third enclosure attached to one of the first and second enclosures.

3. The pet playhouse of claim 2 wherein the first, second and third enclosures each having a longitudinal axis with the longitudinally axes defining a configuration with width and depth.

4. The pet playhouse of claim 3 wherein the first, second and third enclosures each having at least five sides.

5. The pet playhouse of claim 4 wherein the first, second and third enclosures each having at least six sides and wherein the first enclosure abutting at one side thereof to one side of the second enclosure and the second enclosure abutting at one side thereof to one side of the third enclosure.

6. The pet playhouse of claim 2 wherein the playhouse includes at least a first enclosure, second enclosure and a third enclosure each having a longitudinal axis wherein the longitudinally axes are oriented in a generally V shape.

7. The pet playhouse of claim 2 wherein at least one of the first, second and third enclosures including a window through a sidewall thereof.

8. The pet playhouse of claim 1 wherein at least one of the floors including an ear projecting from a side edge thereof and through a first slot in the sidewall of a respective enclosure through a slot in a sidewall of an adjacent enclosure and then through 2 aligned slots in the adjacent panels of the sidewalls of the adjacent enclosures, said ear having a portion overlying an interior surface of the adjacent enclosure.

9. The pet playhouse of claim 1 wherein the floors having a peripheral edge corresponding generally in size and shape to the transverse cross sectional shape of the interior of the enclosure, said floor having a plurality of side edge portions and including a plurality of ears each projecting from a respective side edge portion, said enclosure having a sidewall with a plurality of slots for receiving said plurality of ears.

10. The pet playhouse of claim 1 wherein at least one of the enclosures including a roof mounted thereto.

11. The pet playhouse of claim 2 wherein the portals each including a hole through a respective floor.

12. The pet playhouse of claim 1 wherein at least one of the enclosures including at least one of an entry precursor and a port precursor.

13. The pet playhouse of claim 12 wherein at least two of the enclosures each including at least one port precursor.

14. A pet playhouse comprising:
a first enclosure with an interior divided into at least two rooms and a plurality of floors and at least one first portal providing access through each floor;
a second enclosure with an interior divided into at least two rooms and a plurality of floors and at least one second portal providing access through each floor, said second enclosure being attached to the first enclosure in side-by-side relation;
a third enclosure with an interior divided into at least two rooms and a plurality of floors and at least one third portal providing access through each floor, said third enclosure being attached to the first enclosure in side-by-side relation;
an entry associated with at least one of the first, second and third enclosures providing ingress to and egress from the respective interior of at least one first, second and third enclosure; and
at least one port forming a passage between the third enclosure and the first enclosure and at least one port providing access between the second enclosure and the first enclosure; each of said first, second and third enclosures having at least five sides and a longitudinal axis, the longitudinal axis are configured to form a generally V shape
wherein each of the enclosures are separate from one another, and wherein each enclosure is formed from a generally flat blank folded at a plurality of fold lines to define a plurality of generally flat vertical walls.

15. The pet playhouse of claim 14 wherein the floors each having a side edge corresponding in size and shape to the transverse cross sectional shape of the interior of the respective first, second and third enclosures and each said floor having a plurality of ears projecting from a respective side edge thereof, the first, second and third enclosures each having a plurality of slots through a respective sidewall thereof each adapted to receive an ear therethrough for mounting the floor to the respective first, second or third enclosure.
